(19) United States
(12) Patent Application Publication
(10) Pub. No.: US 2022/0249328 A1
(43) Pub. Date: Aug. 11, 2022

(54) A device for equalizing the pressure inside a baby bottle

(71) Applicant: Artsana S.p.A., Grandate CO (IT)

(72) Inventors: Francesco GATTI, Villa Guardia CO (IT); Sara MARTIGNONI, Grandate CO (IT)

(21) Appl. No.: 17/610,750

(22) PCT Filed: May 11, 2020
(86) PCT No.: PCT/IB2020/054437

§ 371 Date: Nov. 12, 2021

(30) Foreign Application Priority Data
May 15, 2019 (IT) 102019000006869

(51) Int. Cl. A61J 9/04; A61J 11/00; A61J 11/04

(52) U.S. Cl. CPC A61J 9/04; A61J 11/04; A61J 11/0085

(57) ABSTRACT

The invention relates to a device for equalizing the pressure inside a milk-containing baby bottle, by bottom venting, during suction from the nipple.

The device is positioned inside the cover which closes the bottom of the baby bottle.

The cover comprises a dome-shaped element axially emerging from said bottom wall, which has at least one hole located in its cusp-shaped end and in communication with the environment outside the cover.

A diaphragm member with a flexible region is placed above said dome-shaped element of the cover and, when the device is mounted in the bottle, is arranged axially above said hole.

A central disk-shaped element is provided in the flexible region and has at least one cut that opens toward the hole and hence toward the exterior of the bottle, as milk is being sucked, and equalizes the pressure inside the bottle.

The flexibility of the flexible region is obtained, in particular, by the presence of a central dome-shaped region, an annular depression, concentric with said dome-shaped region, located radially outside the latter, and an annular rib, concentric with said depression, located radially outside both said depression and said dome-shaped region.

The present invention relates to a device for equalizing the pressure inside a milk-containing baby bottle during suction from the nipple.

Namely, the invention relates to a device, intended to fulfill the above-stated purpose, in which the interior of the baby bottle is vented from the bottom of the bottle and not by the conventional anti-colic valve. The latter is known to be located in the nipple itself or in the flange that is used to connect the nipple to the mouth of the baby bottle.

Bottom vent devices for baby bottles are known to comprise a diaphragm which rests on a structural part of the bottom of the bottle. In particular, the diaphragm has a calibrated cut formed therein which opens out as a negative pressure is generated in the bottle upon milk suction, thereby providing the intake of an amount of air from the outside, that will equalize the pressure.

The cut in the diaphragm opens to provide venting as a given negative pressure value is attained in the bottle.

This value ranges from a minimum to a maximum which account for various factors, such as: the volume of the baby bottle, the type of liquid to be sucked from the bottle, the need to avoid dripping of milk out of the bottle. In particular, if the bottle is kept in a vertical position, in addition to the suction force exerted through the nipple during milk suction, prior art devices must account for all the above listed factors and do not provide a satisfactory behavior during operation.

In certain cases, excessive suction efforts, in addition to causing fatigue in the baby, also generated health problems such as, for example, the occurrence of ear infections.

The object of the present invention is to provide a device for bottom equalization of the pressure inside a bottom-vented milk-containing baby bottle during suction from the nipple, that can optimize fulfillment of functional requirements imposed on a baby bottle in any bottle volume configuration.

This object is fulfilled by a device that is characterized according to claim 1 as set forth below.

The invention will be now described in greater detail with reference to one embodiment thereof, given by way of illustration and without limitation, and shown in the annexed drawings, in which:

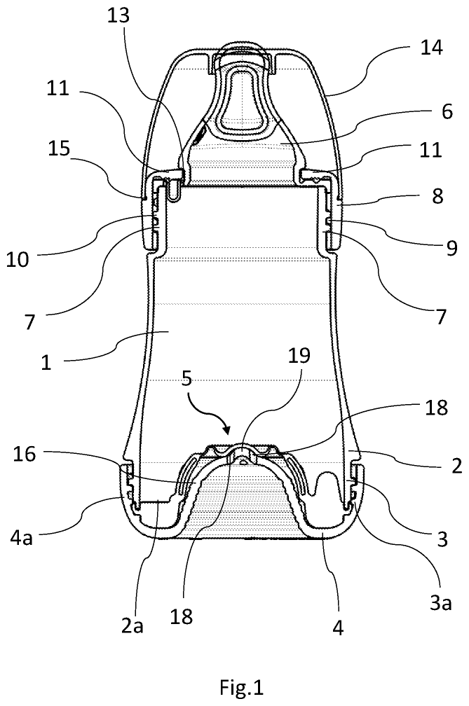

FIG. 1 shows a cross-sectional view of a baby bottle incorporating the device for bottom equalization of the pressure inside the milk-containing bottle;

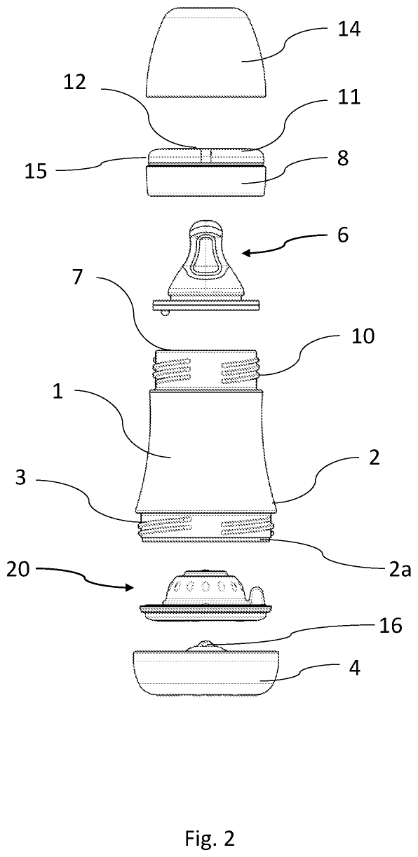

FIG. 2 shows an exploded view of the baby bottle of FIG. 1;

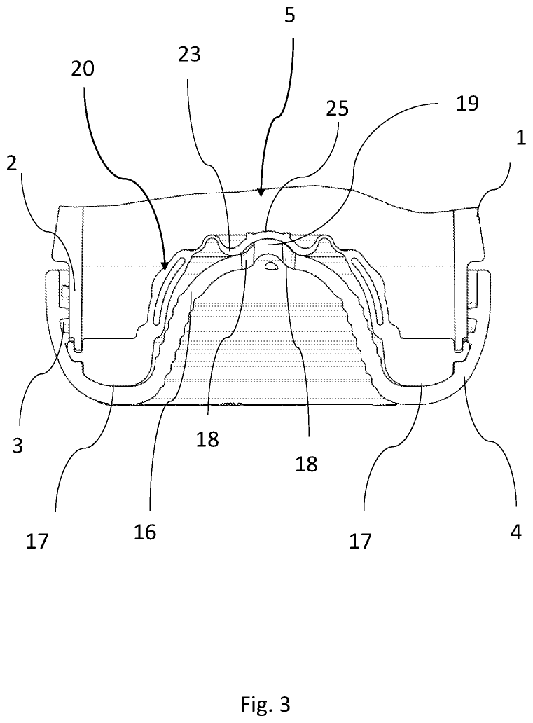

FIG. 3 shows a cross-sectional view of the bottom part of the bottle of the previous figures;

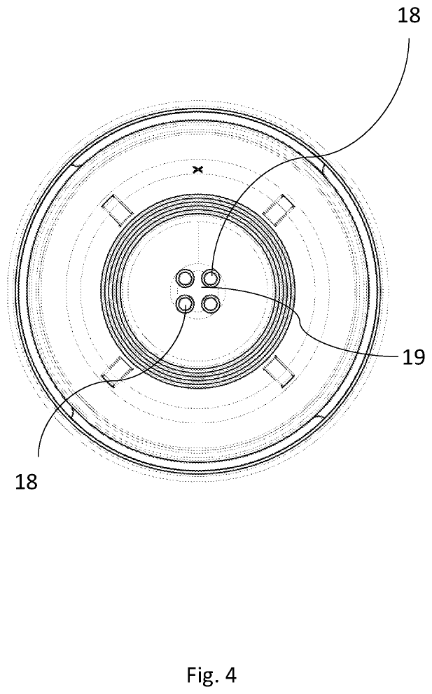

FIG. 4 shows a top view of the bottom part of the bottle;

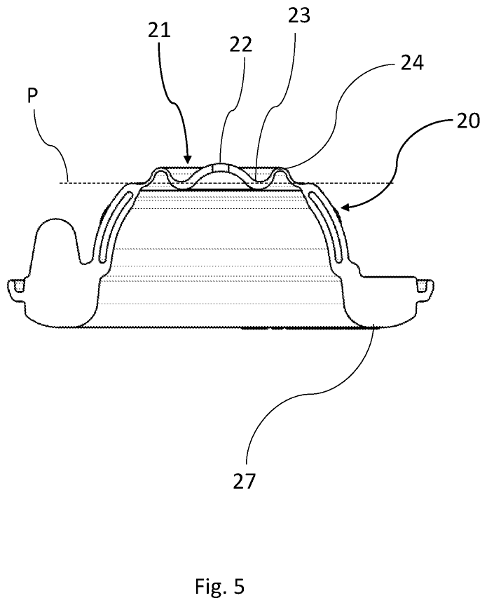

FIG. 5 shows a magnified cross-sectional view of the diaphragm member of the device for bottom equalization of the pressure inside the bottle;

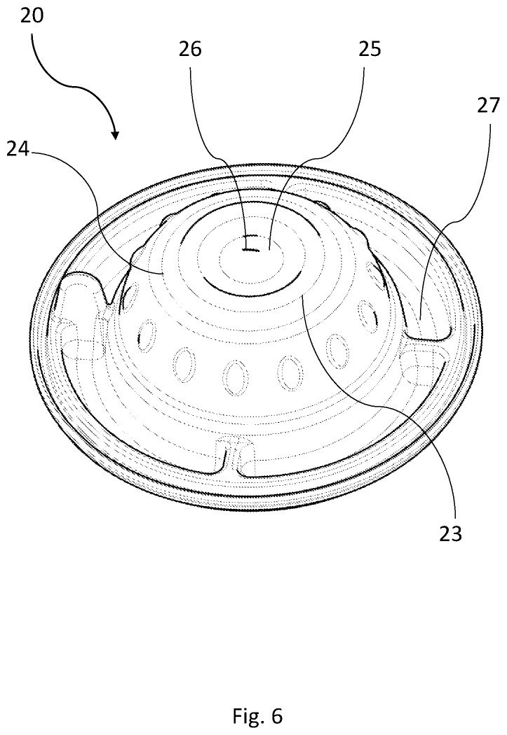

FIG. 6 shows a perspective view of the outer side of the diaphragm member of FIG. 5;

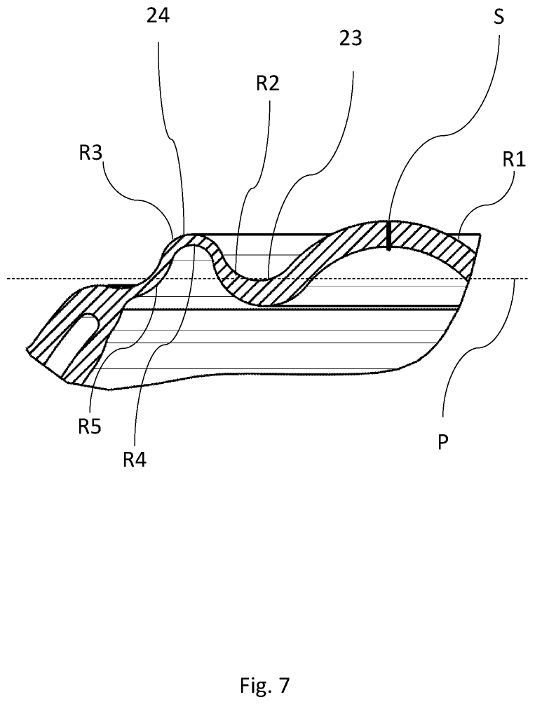

FIG. 7 shows a magnified partial sectional view of the conformation of a part of the flexible region of the diaphragm member.

Referring to the above figures and in particular FIGS. 1 and 2, numeral 1 designates the bottle containing the liquid to be sucked, namely milk.

The bottom cover 4 for closing the opening 2a is removably connected to the lower end 2, e.g. by means of a first screw thread 3.

For this purpose, the cover 4 has an axially raised edge 4a, with a second screw thread 3a formed therein.

The cover 4 in turn, comprises the vent device of the invention, generally referenced 5. This device is intended to equalize the pressure inside the bottle 1, as the liquid is being sucked by the baby from the nipple, generally referenced 6.

Still referring to FIGS. 1 and 2, the nipple 6 is shown affixed to the mouth 7 of the baby bottle 1 by means of a nut 8 having an internal thread 9 designed for engagement with the mating thread 10 of the mouth 7.

Such nut 8 has a radial flange 11 with a central opening 12 for receiving the nipple 6. The latter is locked against the nut 8 because of the engagement of the edge of the opening 12 in the annular groove 13 of the nipple 6

A removable cover 14 for protecting the nipple 6 is conventionally placed on top of the baby bottle with its free edge fitting in an annular recess 15 of the nut 8.

The vent device 5, according to the invention, comprises a dome-shaped element 16 forming part of the cover 4, which axially emerges from the bottom wall 17 of the cover 4.

Such dome-shaped element 16 has at least one hole 18 arranged at the terminal end 19 of the dome element 16. Preferably, the terminal end 19 has a cusp shape with a hole 18 formed around its top. More preferably, a plurality of holes 18 is arranged around the top of the cusp. In the illustrated example, the dome-shaped element 16 has four holes 18 arranged around its cusp-shaped terminal end 19.

The hole 18 is in communication with the environment outside the bottom cover 4.

As namely shown in FIG. 3, a diaphragm member, generally referenced 20, is placed on top of the dome-shaped element 16 and of said bottom wall 17, when mounted in the bottle.

The diaphragm member 20 comprises a flexible region 21, which, when assembled, is positioned axially above the hole 18 formed in the end of said dome-shaped element 16.

In particular, the flexible region 21 of the diaphragm member at least partially abuts the cusp of the cover 4.

Particularly referring to FIGS. 5 and 6, said flexible region 21 is shown to also comprise, in addition to a central dome-shaped region 22 located on top of and in contact with the cusp element 19 when mounted in the baby bottle, an annular depression 23, concentric with said central dome-shaped region 22, located radially outside the latter.

An annular rib 24, concentric with said depression 23, is arranged radially outside the depression and said dome-shaped region 22, and is radially connected to said diaphragm member 20 along a circumferential line which delimits an ideal geometric reference plane referenced P.

With respect to such reference geometric plane P, said depression 23 extends below, whereas said central dome-shaped region 22 extends above.

Particularly referring to FIG. 6, said central dome-shaped region 22 of the flexible region 21 is shown to have a disk-shaped element 25. Preferably, the disk-shaped element 25 is formed of one piece with the central dome-shaped region 22.

According to a preferred embodiment, the flexible region 21 comprises one or more cuts 26 which are designed to vent the bottle during suction of the liquid contained in the bottle 1 from the nipple 6. In other words, the cuts 26 are configured to open and establish fluid communication between the outside environment and the interior of the baby bottle during suction.

It should be noted that the position of the flexible region and in particular the central dome-shaped region 22 on the cusp on which one or more holes 18 are formed ensures a seal when the bottle is not in use. Pressure variations caused by suction and the resulting movement of the central dome-shaped region 22 away from the cusp establish fluid communication between the interior of the baby bottle and the outside environment through the holes 18 and the cuts 26.

In a preferred configuration ensuring proper operation of the baby bottle, the cuts 26, according to the invention, have an ideal length ranging from 3.5 and 2 mm, preferably of 2.5 mm. According to a preferred embodiment, each cut 26 is formed without removing material from the flexible portion. Preferably, each cut 26 is obtained by tearing or cutting the flexible portion, thus avoiding any material removal. Advantageously, each cut 26 thus obtained avoids undesired fluid leakages when in the closed position.

According to a preferred embodiment, the annular rib 24 comprises one or more cuts 26. Preferably, the cuts 26 are spaced apart from each other along the annular rib 24 to create a uniform passage of air from the outside environment to the inside environment. More preferably, the cuts 26 are equally spaced from each other along the annular rib 24. Advantageously, the arrangement of the plurality of cuts 26 along the annular rib 24 facilitates the passage of the air in the vented configuration while reducing the effort that the baby has to make to drink from the nipple.

According to one embodiment, alternative to the one discussed above, the disk-shaped element 25 comprises at least one cut 26 for proper venting from the bottom of the baby bottle.

As shown in FIG. 5, the diaphragm member 20 has an annular channel 27 whereby it is positioned against the bottom wall 17 of the cover 4, when the baby bottle is assembled for use.

It was found that, in order to ensure proper operation of the vent device of the baby bottle, the configuration of the flexible region 21 of the diaphragm 20, as shown in FIG. 7, should appropriately and conveniently meet the following conditions:
the thickness S of the disk-shaped element 25 in which the cut 26 is formed to vent the baby bottle as liquid is being sucked from the nipple 6, shall range from 1.5 to 1 mm, and be preferably 1.2 mm;
the radius of curvature R1 of the outer surface of the central dome-shaped region 22 of the flexible region 21, shall be 6.2 mm;
the radius of curvature R2 of the outer surface of the annular depression 23 shall be 1.9 mm:
the radius of curvature R3 of the outer surface of the annular rib 24 of the flexible region 21 shall be 1.5 mm;
the radius of curvature R4 of the inner surface of the annular depression 23 of the flexible zone 21, facing said reference geometric plane P, shall be 1 mm;
the radius of curvature R5 of the inner surface of said annular rib 24, facing said reference geometric plane P, shall be 2.5 mm;
the thickness of the annular depression 23 under the reference geometric plane P shall range from 1 to 2 mm, and shall be preferably 1.2 mm.

Concerning the material, in order to ensure proper operation of the device, and the diaphragm 20 in particular, a material with a shore hardness 40 and with a nominal modulus of elasticity of 770*10⁵ Pa shall be selected.

With this configuration and this type of material, optimal operating conditions have been found to be achieved for the venting cuts 26, which provide effective re-equalization of the pressure difference occurring inside the baby bottle as liquid is sucked therefrom.

It should also be noted that the higher the negative pressure inside the baby bottle, the greater the deformation of the diaphragm 20 and therefore the greater the opening of the one or more venting cuts 26, which affords effective re-equalization of the pressure difference.

1) A device for equalizing the pressure created in a bottom-vented baby bottle, when sucking on the nipple, comprising an opening on the bottom of the bottle, a first thread formed in a section of the outer wall of the bottle adjacent to said opening, a removable cover for closing said opening, said cover having an edge that is axially raised relative to a bottom wall, a second thread formed in the inner wall of the raised edge, said second thread being configured to engage and disengage said first thread, characterized in that said cover comprises a dome element axially emerging from said bottom wall and having a terminal end, said dome element having at least a hole, said hole being in communication with the environment outside the cover and being located at the terminal end of said dome element, a diaphragm member lying on said dome element and said bottom wall, said diaphragm member having a flexible region axially placed above the hole formed in the terminal end of said dome element, said flexible region of said diaphragm member comprising one or more venting cuts.

2) A device as claimed in claim 1, characterized in that said terminal end of said dome element has a cusp shape.

3) A device as claimed in claims 1 and 2, characterized in that said flexible region of said diaphragm member comprises a central dome-shaped region, an annular depression, concentric with said dome-shaped region, and extending radially outwards from said dome-shaped region, an annular rib concentric with said depression and extending radially outwards from said depression and said dome-shaped region, said annular rib being radially connected to said diaphragm member and said central dome-shaped region contacting said cusp-shaped element.

4) A device as claimed in claim 3, characterized in that said central dome-shaped region has a disk-shaped element placed axially above the hole formed in the terminal end of said dome-shaped element.

5) A device as claimed in claim 3, characterized in that said annular rib comprises one or more cuts.

6) A device as claimed in claim 3, characterized in that said central dome-shaped region comprises one or more cuts.

7) A device as claimed in claims from 3 to 6, characterized in that said annular rib is radially connected to said diaphragm along a circumferential line of a reference geometric plane, said depression being placed below said reference geometric plane and said central dome-shaped region being placed above it.

8) A device as claimed in claims 3, 4 and 7, wherein said central dome-shaped region comprises a disc-shaped relief with a thickness ranging from 1 to 2 mm.

9) A device as claimed in claims 3, 4 and 7, wherein the thickness of the annular depression under the reference geometric plane is 1.2 mm.

10) A device as claimed in claims 3, 4 and 7, wherein the radius of curvature of the outer surface of said central dome-shaped region is 6.2 mm.

11) A device as claimed in claims 3, 4 and 7, wherein the radius of curvature of the outer surface of said annular depression is 1.9 mm.

12) A device as claimed in claims 3, 4 and 7, wherein the radius of curvature of the inner surface, facing said reference geometric plane, of said depression is 1 mm.

13) A device as claimed in claims 3, 4 and 7, wherein the radius of curvature of the outer surface of said annular rib is 1.5 mm.

14) A device as claimed in claims 3, 4 and 7, wherein the radius of curvature of the inner surface, facing said reference geometric plane, of said annular rib is 2.5 mm.
